(19) United States
(12) Patent Application Publication
(10) Pub. No.: US 2014/0053152 A1
(43) Pub. Date: Feb. 20, 2014

(54) APPARATUS, SYSTEM, METHOD AND COMPUTER-READABLE MEDIUM FOR CONTROLLING VIRTUAL OS

(71) Applicant: KABUSHIKI KAISHA TOSHIBA, Tokyo (JP)

(72) Inventors: Yasuyuki KOZAKAI, Kanagawa (JP); Kotaro Ise, Kanagawa (JP)

(73) Assignee: KABUSHIKI KAISHA TOSHIBA, Tokyo (JP)

(21) Appl. No.: 13/966,719

(22) Filed: Aug. 14, 2013

(30) Foreign Application Priority Data
Aug. 15, 2012 (JP) 2012-180121

(51) Int. Cl. G06F 9/455

(52) U.S. Cl. CPC G06F 9/45533
USPC 718/1

(57) ABSTRACT

An apparatus for controlling a virtual OS according to an embodiment comprises a scheduler configured for calculating a resource for zero or more first virtual machines included in a first group constructed from one or more virtual machines, calculating a ratio of an executing period with respect to a cycle of the resource, based on a throughput and a first occupancy of a processor at a time when the processor processes a first traffic and on a volume of a second traffic which is transmitted or received by zero or more second virtual machines included in the first group, calculating a second occupancy of the processor for processing the second traffic of the zero or more second virtual machines by the processor, and calculating the ratio of the zero or more first virtual machines and a sum of the second occupancies with respect to the zero or more second virtual machines.

### CROSS-REFERENCE TO RELATED APPLICATION(S)

This application is based upon and claims the benefit of priority from the Japanese Patent Application No. 2012-180121, filed on Aug. 15, 2012; the entire contents of which are incorporated herein by reference.

### FIELD

An embodiment described herein relates generally to an apparatus, a system, a method and a computer-readable medium for controlling a virtual OS.

### BACKGROUND

Conventionally, there is a virtualization technology by which a plurality of OSs (operating system) can execute on a single node. Furthermore, there is a technology for distributing a load of a virtual OS.

However, in the conventional technique, allocation of virtual machines in a system is decided only based on a load of each virtual machine. Therefore, when a virtual machine executed on a certain node is displaced to the other node, because a processor resource is consumed by a network processing in a target node, for instance, it is not always possible to acquire a sufficient processor resource for all the tasks. Especially, in a case where real-time executions are required for tasks targeted for displacement and tasks executed on the target node, there is a possibility that the tasks will not operate due to insufficiency of the processor resource.

### BRIEF DESCRIPTION OF THE DRAWINGS

FIG. 1 is a block diagram showing an example of an outline structure of an information processing system according to an embodiment;

FIG. 2 is an illustration for explaining a definition of a requirement of a periodic task in detail;

FIG. 3 is a table showing an example of a system parameter stored in a storage according to the embodiment;

FIG. 4 is a table showing an example of a task requirement and a traffic volume stored in the storage according to the embodiment;

FIG. 5 is a sequence diagram showing an operation of the information processing system according to the embodiment; and

FIG. 6 is a flowchart showing an operation of a scheduler in Step S16 of FIG. 5.

### DETAILED DESCRIPTION

Exemplary embodiments of an apparatus, a system, a method and a computer-readable medium for controlling a virtual machine will be explained below in detail with reference to the accompanying drawings.

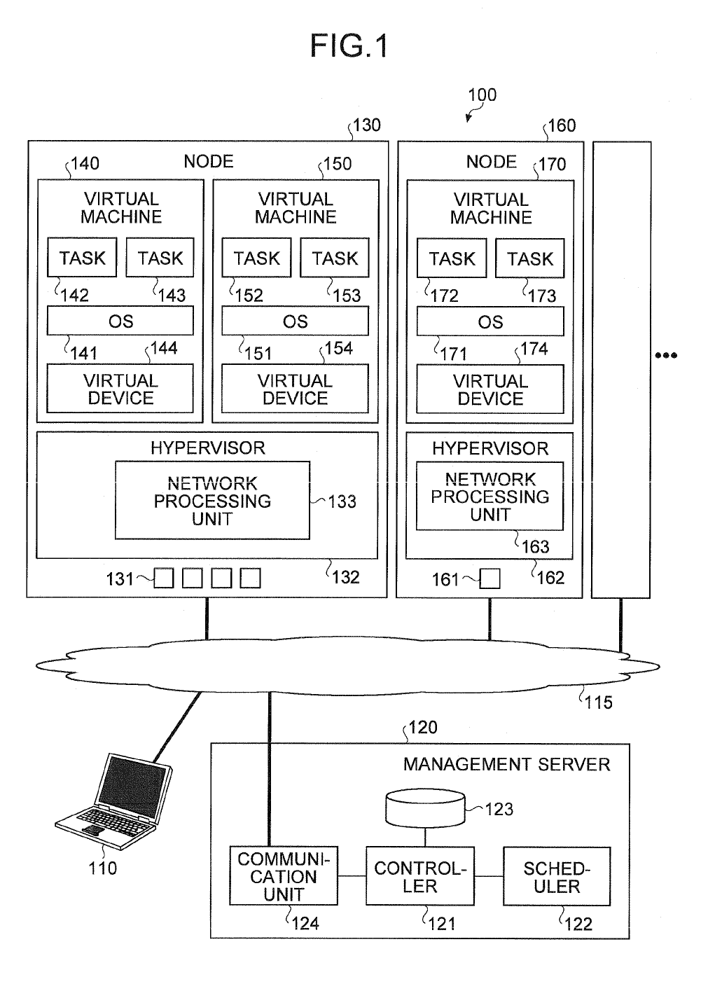

In the following, an apparatus, a system, a method and a program for controlling a virtual machine according to an embodiment will be described in detail with accompanying drawings. FIG. 1 shows an example of an outline structure of an information processing system according to the embodiment.

As shown in FIG. 1, an information processing system 100 according to the embodiment has one or more nodes 130 and 160, a network 115, a management server 120 and a client 110.

The management server 120 includes a communication unit 124, a controller 121, a scheduler 122 and a storage 123. The communication unit 124 may has an Ethernet® processing unit, a TCP/IP stack, a HTTP server, and so forth. Each portion in the communication unit 124 can be constructed as software or hardware. The controller 121 communicates with each hypervisor 132 and 162 in the nodes 130 and 160 and controls virtual machines 140, 150 and 170. For example, the controller 121 orders the hypervisor 132 to create the new virtual machine 140 or 150 in the node 130.

The controller 121 can order the hypervisor 132 to displace one or more of the virtual machines 140 and 150 executed on one node 130 to the other node 160. Likewise, the controller also can order the hypervisor 162 to displace one or more of tasks 172 and 173 executed on one node 160 to the other node 130.

The scheduler 122 calculates resources to be allocated tc each of the virtual machines 140, 150 and 170, each of virtual devices 144, 154 and 174, and a network processing unit 133. Definitions of a task requirement and a resource will be described later on.

Furthermore, the scheduler 122 acquires requirements of one or more tasks from the controller 121, and calculates a resource to be allocated to each of the virtual machines 140, 150 and 170 based on the acquired task requirements. The scheduler 122 outputs the calculated resource to the controller 121.

Here, in the embodiment, tasks 142, 143, 152, 153, 172 and 173 are periodic tasks. The periodic task is a task requiring execution of a process within a constant amount at regular intervals.

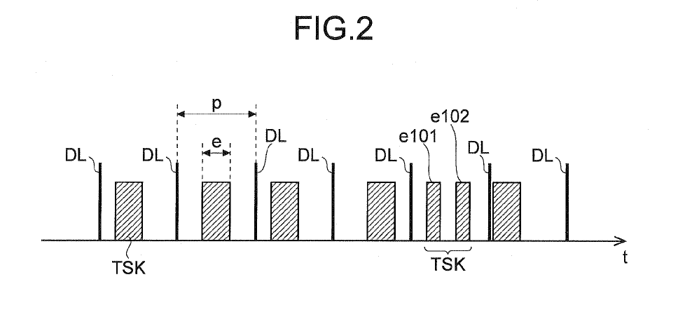

A definition of the requirement of the periodic task will be described in detail using FIG. 2. TSK in FIG. 2 shows examples of the periodic tasks. Shadow areas show periods during which the processor executes the periodic tasks TSK. DL shows deadlines of the periodic tasks TSK. Intervals between the deadlines DL are constant. Each requirement of the periodic task TSK is defined by a pair (p, e) being a period p of the deadline DL and a maximum processing period e for processing the periodic task TSK. Units of the period p and the maximum processing period e are decided by a minimum time in which a periodic task TSK can be executed continuously without stopping.

In order to let the periodic task TSK maintain a normal operation, the processor should execute the periodic task TSK for a period of time greater than a maximum processing period e for every period p. For instance, when units of the period p and the maximum processing period e are 1 ms (millisecond) and a requirement of one periodic task TSK is (1, 200), the processor should execute the periodic task TSK for 1 ms for every 200 ms in order to maintain the normal operation of the periodic task TSK. At this time, as shown by executing periods e100 and e102, the processor can divide the periodic task TSK in two or more and execute the divided periodic tasks TSKs during the period e. In this case, a sum of the executing periods e101 and e102 should be equal to or greater than the maximum processing period e.

In the information processing system 100 according to the embodiment, a processor 131 of the node 130 concurrently executes one or more tasks by switching the running task. However, it is not limited to such structure, while the node 130 can have a plurality of the processors 131 in order to allow execution of a plurality of tasks in parallel.

An OS 141 orders the hypervisor 132 or the processor 131 so that the tasks 142 and 143 in the virtual machine 140 are switched as necessary. Likewise, an OS 151 orders the hypervisor 132 or the processor 131 so that the tasks 152 and 153 in the virtual machine 150 are switched as necessary. The task having been ordered to be switched by the OS 141 is limited to the tasks 142 and 143 executed on the virtual machine 140. Likewise, the task having been ordered to be switched by the OS 151 is limited to the tasks 152 and 153 executed on the virtual machine 150.

The hypervisor 132 orders the processor 131 so that the running virtual machine is switched as necessary. For instance, the hypervisor 132 switches the running virtual machine from the virtual machine 150 to the virtual machine 140. The OS 141 of the selected virtual machine 140 switches the running task to either one from between the tasks 142 and 143. Likewise, the node 160 and the virtual machines 150 and 170 also switch the running virtual machine and the running task. According to the above, scheduling is executed hierarchically.

For instance, when the processor executes the virtual machine 140, a resource to be allocated to the virtual machine 140 is defined by a pair (π, Θ) being a cycle π during which the virtual machine 140 is executed by the processor 131 and an executing period Θ per cycle. That is, the virtual machine having the resource (π, Θ) being allocated to is executed for a period of time Θ time in total for every cycle π. Units of a period π and an executing period Θ are defined by a minimum time that can be allocated to a virtual machine, for instance.

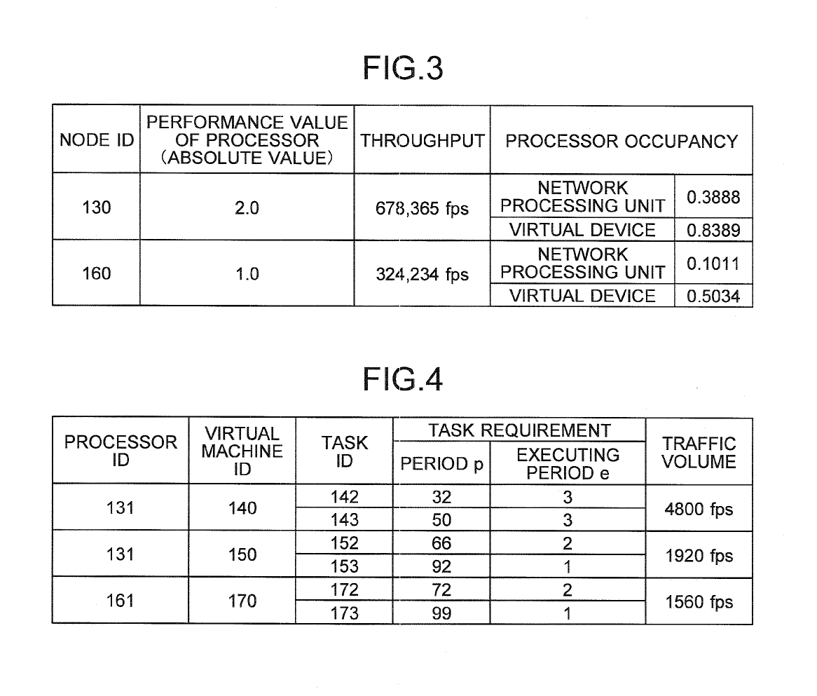

The storage 123 of the management server 120 shown in FIG. 1 stores a system parameter of each of the nodes 130 and 160. FIG. 3 shows an example of the system parameter stored in the storage 123. As shown in FIG. 3, the system parameter includes a node ID, a performance value, a throughput and a processor occupancy. The node ID is an identifier for identifying the nodes 130 and 160. The performance value of each of processors 131 and 161 may be a processing speed. For example, the performance value of the processor 131 may represent a ratio of a necessary time for a certain processor to execute a certain amount of process to a necessary time for the processor 131 to execute the same amount of process. For instance, when the necessary time for a certain processor to execute the certain amount of process is d1 and the necessary time for the processor to execute the same amount of process is d2, the performance value of the processor 131 may be d1/d2. A definition of the performance value of the processor 161 is the same as that of the performance value of the processor 131.

The throughput is the number of frames each node can process per second or an amount of communication data. The processor occupancy is an occupancy of the processor necessary for each network processing unit and each virtual device for achieving the throughput shown in FIG. 3. In the example of FIG. 3, the system parameter includes a processor occupancy with respect to network processing units 133 and 163 and the virtual devices 144 and 174. A virtual device 154 has the same structure as the virtual device 144. Therefore, because a processor occupancy of the virtual device 154 is the same as the occupancy of the virtual device 144, the system parameter shown in FIG. 3 does not include the occupancy of the virtual device 154. However, it is not limited to such structure, while the system parameter can include processor occupancies of all the virtual devices.

The storage 123 stores a task requirement of each task and a traffic volume of transmission and reception by a virtual machine together with a processor ID, a virtual machine ID and a task ID. FIG. 4 shows an example of a task requirement and a traffic volume stored in the storage 123. As shown in FIG. 4, the traffic volume indicates the number of frames that each virtual machine transmits and receives per second. In the example of the embodiment, the storage 123 stores traffic volumes of transmission and reception by the virtual machines 140, 150 and 170. In addition, although values of the period p and the executing period e shown in FIG. 4 are natural numbers, they are not limited to the natural numbers as long as they are positive numbers. Furthermore, the period p and the executing period e can be stored at any format.

The nodes 130 and 160 are computers each having a physical memory (not shown) and the processor 131 or 161. In the example shown in FIG. 1, the node 130 has the hypervisor 132 constructed as software or hardware and the virtual machines 140 and 150. Likewise, the node 160 has the hypervisor 162 constructed as software or hardware and the virtual machine 170.

The hypervisor 132 of the node 130 executes one or more virtual machines including the virtual machines 140 and 150 for allowing execution of one or more OSs 141 and 151 on the node 130. The hypervisor 132 further has the network processing unit 133. Likewise, the hypervisor 162 of the node 160 has the network processing unit 163, and executes one or more virtual machines including the virtual machine 170 for allowing execution of one or more OSs 171 on the node 160.

The virtual machine 140 executes the OS 141 and the tasks 142 and 143. Likewise, the virtual machines 150 executes the OS 151 and the tasks 152 and 153. The virtual machine 170 executes the OS 171 and one or more tasks including the tasks 172 and 173. For instance, the OSs 141, 151 and 171 and the tasks 142, 143, 152, 153, 172 and 173 are constructed as software or hardware, respectively.

The virtual machine 140 further has the virtual device 144. The virtual device 144 delivers frames between the network processing unit 133 and the OS 141. Likewise, the virtual machine has the virtual device 154, and the virtual machine 170 has the virtual device 174.

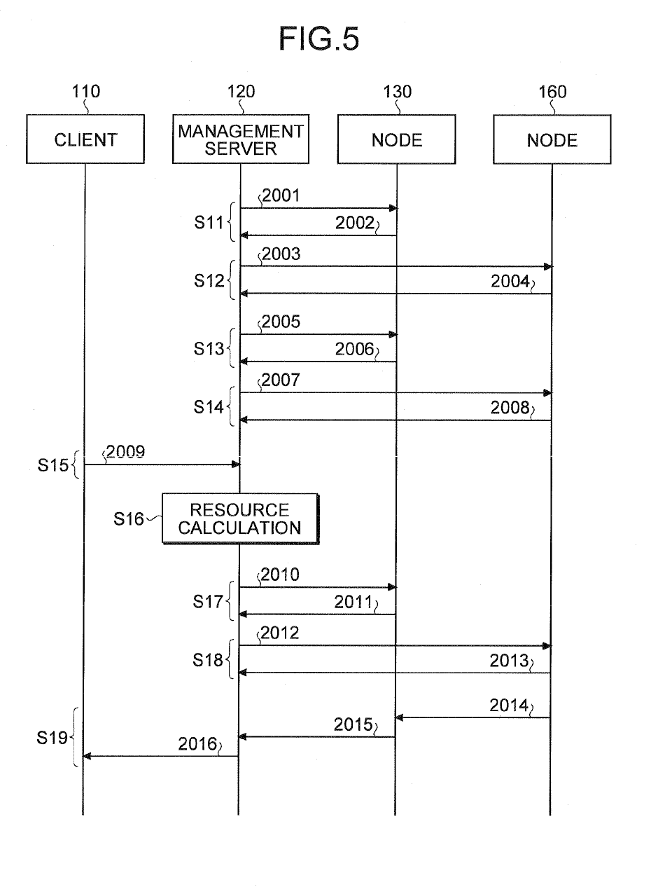

Next, using a sequence diagram shown in FIG. 5, an operation of the information processing unit 100 according to the embodiment will be described in detail. As shown in FIG. 5, firstly, in Step S11, the management server 120 obtains a system parameter from node 130.

Specifically, the controller 121 of the management server 120 sends a massage 2001 to the communication unit 124. The message 2001 includes a description for requesting the system parameter of the node 130. The communication unit 124 of the management server 120 executes a protocol processing such as Ethernet®, TCP (transmission control protocol), IP (internet protocol), HTTP (HyperText transfer protocol), or the like, on the massage 2001 and sends the massage 2001 to the node 130 via the network 115 shown in FIG. 1. In the following, in steps where the controller 121 of the management server 120 will send massages to the nodes 130 and 160, the communication unit 124 will likewise execute the protocol processing such as Ethernet®, TCP, IP, HTTP, or the like, to the massages. The protocol-processed massages will be transmitted via the network 115.

The node 130 having received the massage 2001 sends a massage 2002 to the management server 120 via the network 115. The massage 2002 includes the system parameter of the node 130. The communication unit 124 of the management server 120 executes a protocol processing such as Ethernet®, TCP, IP, HTTP, or the like, on the massage 2002 and sends the processed massage 2002 to the controller. In the following, in steps where the controller 121 of the management server 120 receives massages, the communication unit 124 will likewise execute the protocol processing such as Ethernet®, TCP, IP, HTTP, or the like, to the massages. The controller 121 having received the massage 2002 stores the system parameter included in the massage 2002 in the storage 123.

Next, in Step S12, the management server 120 obtains a system parameter from the node 160 using a massage 2003 including an order for requesting the system parameter and a massage including the system parameter of the node 160, and stores the system parameter in the storage 123. The process of Step S12 can be the same as that of Step S11.

Next, in Step S13, the management server 120 obtains the requirements of the tasks 142, 143, 152 and 153 from the node 130 and the traffic volumes of the virtual machines 140 and 150. Specifically, the controller 121 of the management server 120 sends a massage 2005 to the node 130. The massage 2005 includes an order for requesting the requirements of one or more tasks 142, 143, 152 and 153 executed on the node 130 and an order for requesting the traffic volumes of the virtual machines 140 and 150. The node 130 having received the massage 2005 sends a massage 2006 to the management server 120. The massage 2006 includes one or more requirements of the tasks 142, 143 152 and 153 executed on the node 130 and the traffic volumes of the virtual machines 140 and 150. When the management server 120 receives the massage 2006, the controller 121 of the management server 120 stores the task requirements and the traffic volumes described in the massage 2006 in the storage 123.

Next, in Step S14, the management server 120 sends a massage 2007 including an order for requesting the task requirements and the traffic volumes, and receives a massage 2008 including requirements of the tasks 172 and 173 and a traffic volume of the virtual machine 170 from the node 160. A process of Step 514 can be the same as the process of Step S13.

Next, in Step S15, the client 110 sends a massage 2009 to the management server 120. The massage 2009 includes a virtual machine ID of the virtual machine 170, a node ID of the node 160, a node ID of the node 130, and a code for ordering displacement of the virtual machine.

When the management server 120 receives the massage 2009, the controller 121 of the management server 120 sends the virtual machine ID of the virtual machine 170, the node ID of the node 160, the node ID of the node 130, and the system parameter and task requirements stored in the storage 123 to the scheduler 122.

Next, in Step S16, the scheduler 122 of the management server 120 calculates optimal resources for the virtual machines 140, 150 and 170, the network processing unit 133, and the virtual devices 144, 154 and 174, and determines whether or not the resources are enough for them. Detail descriptions of an operation of the scheduler 122 in Step S16 will be described later on.

In the determination of Step S16, when the scheduler 122 determines that there are enough resources, the controller 121 of the management server 120 orders the node 130 to displace the virtual machine 170 in Step S17. Specifically, the controller 121 of the management server 120 sends a massage 2010 to the node 130. The massage 2010 includes the node ID of the virtual machine 170. The node 130 having received the massage 2010 sends a massage 2011 to the management server 120. The massage 2011 includes a code indicating whether or not the node 130 accepts the displacement of the virtual machine 170.

Next, in Step S18, the controller 121 of the management server 120 orders the node 160 to displace the virtual machine 170. Specifically, the controller 121 of the management server 120 sends a massage 2012 to the node 160. The massage 2012 includes the virtual machine ID of the virtual machine 170. The node having received the massage 2013 sends a massage 2013 to the management server 120. The management server 2013 includes a code indicating whether or not the node 160 accepts the displacement of the virtual machine 170.

Next, in Step S19, the node 160 sends an image 2014 of the virtual machine 170 to the node 130. The image 2014 of the virtual machine 170 can includes an execution memory image of the virtual machine 170. The node 130 having received the image 2014 reads in the execution memory image of the virtual machine 170 into a memory (not shown) and boots the virtual machine 170. Then, the node 130 sends a massage 2015 including a code indicating the completion of the displacement of the virtual machine 170 to the management server 120. The controller 121 of the management server 120 having received the massage 2015 sends a massage 2016 to the client 110. The massage 2016 includes a code indicating the completion of the displacement of the virtual machine 170.

By the above processes, the displacement of the virtual machine 170 executed on the node 160 to the node 130 is completed.

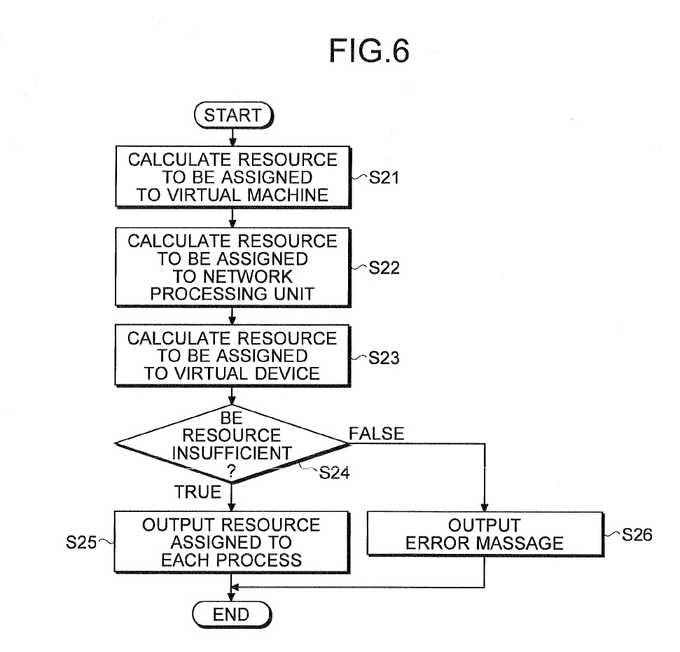

Next, an operation of the scheduler 122 in Step S16 of FIG. 5 will be described in detail using a flowchart shown in FIG. 6. The performance value of the processor 131 of the node 130 differs from the performance value of the processor 161 of the node 160. Therefore, the resource for the virtual machine 170 allocated by the node 160 may not be optimal in the node 130.

Accordingly, as shown in FIG. 6, the scheduler 122 calculates optimal resources to be allocated to the virtual machines 140, 150 and 170 (Step S21).

A method for calculating the optimal resources depends on a scheduling method directed to the virtual machines 140, 150 and 170 in the hypervisor 132 and scheduling methods of the virtual OSs 141, 151 and 171. In a case where the hypervisor 132 and the virtual OSs 141, 151 and 171 execute the scheduling on the basis of a rate monotonic scheduling, the scheduler 122 may calculate the optimal resources for the virtual machines 140, 150 and 170 using the method described in Reference 1; “Realizing Compositional Scheduling through Virtualization” by Jaewoo Lee, Sisu Xi, Sanjian Chen, Linh T. X. Phan, Christopher Gill, Insup Lee, Chenyang Lu, and Oleg Sokolsky, IEEE Real-Time and Embedded Technology and Applications Symposium (RTAS), April, 2012.

Next, in Steps S22 and S23, the scheduler 122 calculates resources to be allocated to processes on a traffic transmitted and received by the virtual machines 140, 150 and 170.

The process on the traffic transmitted and received by the virtual machine 140 can be divided into a process in the network processing unit 133 and a process in the virtual device 144. Likewise, the network processing unit 133 and the virtual device 154 process the traffic transmitted and received by the virtual machine 150. Furthermore, the network processing unit 133 and the virtual device 174 process a traffic transmitted and received by the virtual machine 170. The scheduler 122 calculates a resource for each process.

Definitions of the resources to be allocated to the network processing unit 133 and, the virtual devices 144, 154 and 174 are different from those of the resources to be allocated to the virtual machines 140, 150 and 170, and are represented by occupancies of the processor. The scheduler 122 calculates a resource to be allocated to the network processing unit 133 using the system parameter stored in the storage 123 and the traffic volumes of transmission and reception by the virtual machines 140, 150 and 170 (Step S22).

The node 130 can execute the processes of the network processing unit 133 in parallel using a plurality of processors. For instance, the node 130 can be structured so that frames to be processed by each processor are decided based on destination addresses or source addresses of the frames. In this case, the resource to be allocated to the network processing unit 133 can be different for each processor. Likewise, the node 160 can execute the processes of the network processing unit 163 in parallel using a plurality of processors.

The scheduler 122 calculates a resource Fnw(C) to be used for executing the network processing unit by each processor using a following formula (1).

$$Γvm ( C ) = \frac{Unw}{Th} \cdot {\sum }_{VM ( i ) ∈ Svm ( C )}^{ } Tvm ( i ) \qquad ( 1 )$$

In the formula (1), n virtual machines operating on the node 130 before the displacement of the virtual machine 170 are defined as VM(1), VM(2), . . . VM(n), respectively. The virtual machine 170 to be displaced is defined as VM(n+1). Tvm(i) is a traffic volume of a virtual machine VM(i). Th is a throughput, which is a part of the system parameter, in the node 130. For example, in the case of the traffic volume shown in FIG. 3, Th is 678,365 fps. Unw is an occupancy of processor, which is a part of the system parameter, of the network processing unit. For example, in the case of the system parameter shown in FIG. 3, Unw is 0.3888. Svm(C) is a set of virtual machines which which frames to be processed by the processor C are transmitted. Svm(c) may be equal to or not equal to the set {VM(1), VM(2), . . . VM(n), VM(n+1)}.

Then, the scheduler 122 calculates the resources to be allocated to the virtual devices 144, 154 and 174 using the system parameter stored in the storage 123 and the traffic volumes of transmission and reception by the virtual machines 140, 150 and 170 (Step S23).

At least one virtual device is installed in each of the virtual machines 140, 150 and 170. As the node 130 shown in FIG. 1, when the node 130 has a plurality of processors 131, two or more processors 131 can execute each of the virtual devices 144 and 154 in parallel. For instance, after the virtual machine 170 is displaced, if a sum of processing load of the virtual devices 144, 154 and 174 exceeds a capacity of a single processor 131, one or more processors 131 can be assigned to each of the virtual devices 144, 154 and 174.

The scheduler 122 calculates a total amount Fvd(C) of resources to be allocated to one or more virtual devices executed by a certain processor C using a following formula (2).

$$Γ vd ( C ) = \frac{Uvd}{Th} \cdot {\sum }_{VM ( i ) ∈ Svd ( C )}^{ } Tvm ( i ) \qquad ( 2 )$$

In the formula (2), Svd(C) shows a set of virtual machines to which the virtual device executed by the processor C belongs. Uvd is defined as an occupancy of a processor of a virtual device in the system parameter. For example, in a case where the virtual machine 170 is to be displaced to the node 130 and the system parameter is such data shown in FIG. 3, Uvd is 0.8389.

Next, the scheduler 122 determines whether the resource is enough or not (Step S24). In order to suppress variations in process delay of frames as much as possible, the node 130 may be structured so that processes of the virtual machines 140, 150 and 170, the network processing unit 133, and the virtual devices 144, 154 and 174 are executed on different processors. However, it is not limited to such structure, while it is also possible that the node 130 is structured so that the virtual machines 140, 150 and 170, the network processing unit 133, and the virtual devices 144, 154 and 174 are executed on a single processor.

Here, a necessary resource I′ for all the virtual machines executed by a certain processor C is defined as F(C)=(π(C), Θ(C)), and an occupancy Ψ(C) thereof is defined as π(C)/Θ(C). In this case, when there is a processor of which Ψ(C)+Γvm(C)+Γvd(C) exceeds 1, the scheduler 122 outputs false as a result of Step S24 (Step S24). On the other hand, when there is not a processor of which T(C)+Fvm(C)+Fvd(C) exceeds 1, the scheduler 122 outputs true as a result of Step S24 (Step S24). Here, the necessary resource F(C) for all the virtual machines executed on the processor C is not necessarily to the total amount of the occupancies of the optimal resources for the virtual machines.

In a case where the hypervisor 132, the virtual OSs 141 and 151, and the virtual OS 171 in the virtual machine 170 execute scheduling on a basis of the RMS together, the scheduler 122 may calculate F(C) according to Reference 1, for example.

Next, when a result of Step S24 is true, the scheduler 122 returns the resource allocated to each process to the controller 121 (Step S25). On the other hand, when the result of Step S24 is false, the scheduler 122 returns an error to the controller 121 (Step S26).

In this way, by the process of Step S16 in FIG. 5, the optimal resources for the virtual machines 140, 150 and 170, the network processing unit 133 and the virtual devices 144, 154 and 174 are calculated, and it is determined whether the resources are sufficient or not.

Necessary resources for network processing units and virtual devices of different nodes are different depending on configuration algorithms of the network processing units and the virtual devices and performances of processors in each node. Therefore, as in the embodiment, by executing one or both of Steps S22 and S23 in addition to Step S21 of FIG. 6, in a case where a virtual machine is displaced between nodes having different configurations, it is possible to more accurately estimate a resource required in the destination node before the displacement of the virtual machine. Thereby, a user can know whether the displacement of the virtual machine is possible or not before the virtual machine is displaced. As a result, it is possible to prevent possible resource deficiency in the destination node 130 from occurring.

Furthermore, in the embodiment, the management server 120 can execute the series of Steps S15 to S19 at a timing different from Steps S11, S12, S13 and S14. For example, using the reception of the massage 2009 as an opportunity, the management server 120 can execute a part or all of Steps S11 to S14 in a random order.

Moreover, in the embodiment, the management server 120 can omit a part or all of Steps S11 to S14. For example, if the system parameter and the task requirements are previously stored in the storage 123 of the management server 120, it is possible to omit Steps S11 to S14. In this case, it is possible to shorten the processes of the management server 120. For example, when a virtual machine is displaced or created, the controller 121 of the management server 120 may obtain the system parameter or the task requirements and store it in the storage 123.

Moreover, in the embodiment, the management server 120 and the node 130 can combine Steps S11 and S13. For instance, the management server 120 can send a massage to the node 130, and the node 130 can send a massage including the system parameter and the task requirements to the management server 120. Likewise, the management server 120 and the node 160 can combine Steps S12 and S14.

Furthermore, the management server 120 can executes Step S16 before Step S15. For instance, using a part or all of the system parameter and the task requirements stored in the storage 123, the management server 120 can previously calculate resources to be necessary after each virtual machine is displaced and stores the calculated result in the storage 123, and after which, when receiving the massage 2009, uses the stored resources in stead of the result of Step S16. Thereby, it is possible to shorten the time that takes from the reception of the massage 2009 to the transmission of the massage 2016 with respect to the client 110.

In the embodiment, each of the processors 131 and 161 has a single core, and each of the nodes 130 and 160 has one or more processors, respectively. However, in this embodiment, it is not limited to such structure while the processors 131 and 161 can have a plurality of cores. By such structure, in each of the processors 131 and 161, it is possible to execute a plurality of processes at the same time.

When the processor has a plurality of cores, it is possible to arrange such that the scheduler 122 determines deficiency or excess of resource for every cores in stead of calculating the resource of the processor 131.

Furthermore, in this embodiment, in a case where the node 130 is structured so that the virtual devices 144, 154 and 174 obtain the frames directly from a network interface (not shown) without going through the network processing unit 133, the scheduler 122 can omit the calculation for the necessary resource for the network processing unit 133 in Step S22 and set the resource as ‘0’.

While a certain embodiment has been described, this embodiment has been presented by way of example only, and is not intended to limit the scope of the inventions. Indeed, the novel embodiment described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. Apparatus for controlling a virtual OS comprising:
a scheduler configured for
calculating a resource for zero or more first virtual machines included in a first group constructed from one or more virtual machines,
calculating a ratio of an executing period with respect to a cycle of the resource,
based on a throughput and a first occupancy of a processor at a time when the processor processes a first traffic and on a volume of a second traffic which is transmitted or received by zero or more second virtual machines included in the first group, calculating a second occupancy of the processor for processing the second traffic of the zero or more second virtual machines by the processor, and
calculating the ratio of the zero or more first virtual machines and a sum of the second occupancies with respect to the zero or more second virtual machines.

2. The apparatus according to claim 1, further comprising:
a controller configured for
receiving the throughput and the first occupancy from a first device having the processor,
receiving the volume of the second traffic from a second device, and
sending a massage including the second occupancy to a third device.

3. The apparatus according to claim 1, wherein
the apparatus is interconnected to a first device having the processor and a second device having at least one third virtual machine belonging to the first group via a network,
the scheduler calculates the sum of the second occupancy, and
the controller, when the sum of the second occupancy is less than a predetermined value, orders the first and second devices to displace the third virtual machine from the second device to the first device.

4. The apparatus according to claim 1, wherein
the second occupancy is a processor occupancy of a process at a network processing unit of a device executing the second virtual machine.

4. The apparatus according to claim 1, wherein
the second occupancy is a processor occupancy of a process at a virtual device of the second virtual machine.

6. A system comprising:
the apparatus for controlling a virtual OS according to claim 1, and
first to third devices connected to the apparatus via a network, wherein
the apparatus includes a controller configured for receiving the throughput and the first occupancy of the processor from a first device having the processor, receiving the volume of the second traffic from a second device, and sending a massage including the second occupancy to a third device.

7. A method for controlling a virtual OS including:
calculating a resource for a virtual machine executing one or more tasks;
calculating a ratio of an assigned period with respect to a cycle of the resource,
based on a throughput and a first occupancy of a processor at a time when the processor processes a first traffic and on a volume of a second traffic which is transmitted or received by the virtual machines, calculating a second occupancy of the processor for processing the second traffic of the virtual machines by the processor, and
calculating the ratio of the one or more virtual machines and a sum of the second occupancies.

8. A non-transitory computer readable medium including a program for operating a computer which controls a virtual OS, the program comprising the instructions of:
calculating a resource for a virtual machine executing one or more task;
calculating a ratio of an assinged period with respect to a cycle of the resource,
based on a throughput and a first occupancy of a processor at a time when the processor processes a first traffic and on a volume of a second traffic which is transmitted or received by the virtual machines, calculating a second occupancy of the processor for processing the second traffic of the virtual machines by the processor, and
calculating the ratio of the one or more virtual machines and a sum of the second occupancies.
